(19) United States
(12) Patent Application Publication
(10) Pub. No.: US 2007/0055969 A1
(43) Pub. Date: Mar. 8, 2007

(54) SYSTEM AND METHOD FOR UPDATING FIRMWARE

(75) Inventor: Ping-Chung Yang, Taoyuan (TW)

Correspondence Address: SNELL & WILMER, 400 EAST VAN BUREN, ONE ARIZONA CENTER, PHOENIX, AZ, 85004-2202, US

(73) Assignee: BENQ CORPORATION, Taoyuan (TW)

(21) Appl. No.: 11/469,522

(22) Filed: Sep. 1, 2006

(30) Foreign Application Priority Data
Sep. 6, 2005 (TW) 94130508

(51) Int. Cl. G06F 9/44

(52) U.S. Cl. 717/168

(57) ABSTRACT

A system and a method for updating firmware are disclosed. The system includes a storage device and an electronic device. The storage device has an update code and a backup region for storing a backup code. The electronic device includes a processor, a first memory, and a second memory. The first memory stores an original code and a restore flag. The second memory is used to temporarily store the original code for execution by the processor. The original code is backed up, through the second memory, to the backup region as the backup code. The restore flag is enabled, and the original code in the first memory is replaced by the update code.

### CROSS REFERENCE TO RELATED APPLICATIONS

This application claims priority of Taiwan Patent Application Serial No. 094130508 entitled “SYSTEM AND METHOD FOR UPDATING FIRMWARE,” filed on Sep. 6, 2005.

### FIELD OF INVENTION

The present invention relates to a system and a method for updating firmware or a program, and more particularly, to a system and a method for updating firmware (a program) and restoring the firmware (the program) if the updating process is unsuccessful.

### BACKGROUND OF THE INVENTION

Firmware update is a typical capability of a conventional electronic device to improve the stability or functionality, or sometimes to fix bugs of the device. However, if some unexpected failures occur during the updating process, such as unexpectedly shutdown, the device becomes unbootable due to damage to the firmware, leaving an annoying situation to the user.

Some attempts are made to lower the probability of the unexpected failure, such as that set forth in Taiwanese Patent No. I220962 disclosing a program updating method and a device for assuring the compatibility of an updated program by checking content of the program. A host computer or a control circuit is provided to check the compatibility of the new program code before updating the program by determining whether the new program code conforms with some criteria in order to avoid updating of an incorrect program code to the device. However, even if the program code is confirmed before updating the program, other unexpected failures may still be possible during the updating process, which is especially caused by hardware failures, such as sudden power shutdown or unstable power supply. The problems due to unexpected failures during the updating process are still left unsolved.

U.S. Pat. No. 5,878,256 discloses a method and a device for updating firmware using a plurality of non-volatile memories to store multiple identical or different versions of firmware. When the firmware in one of the memories is updated, the firmware in other memory is configured to be write-protected to preserve the integrity of firmware. Hence, at least one available firmware remains to provide a normal operation of the device after an unexpected failure occurred. However, the multiple non-volatile memories raise manufacturing cost and complexity of the device. In addition, the operations and write-protection controls of multiple memories are more difficult to design compared to the conventional circuit design.

Therefore, it is advantageous to provide a firmware updating method and system to restore original code of firmware after updating failure occurs. When unexpected failure occurs, the system is still capable of reviving from the failure and running the normal operations.

### SUMMARY OF THE INVENTION

It is one aspect of the present invention to provide a firmware updating system and method to restore original code of firmware after an updating failure occurs and to execute normal operation of the system.

A system for updating firmware is disclosed. The system includes a storage device and an electronic device. The storage device has an update code and a backup region for storing a backup code. The electronic device includes a processor, a first memory, and a second memory. The first memory stores an original code and a restore flag. The second memory is used to temporarily store the original code for execution by the processor. The original code is backed up, through the second memory, to the backup region as the backup code. The restore flag is enabled, and the original code in the first memory is replaced by the update code.

A method for updating firmware of an electronic device from a storage device is also disclosed. The electronic device has a first memory and a second memory. An original code is stored in the first memory and an update code is stored in the storage device. The method includes the following steps: (a) setting a temporary region in the second memory; (b) setting a backup region in the storage device; (c) setting a restore flag to be enabled in the first memory; (d) copying the original code to the backup region as a backup code through the temporary region; and (e) replacing the original code in the first memory with the update code through the temporary region.

### BRIEF DESCRIPTION OF THE DRAWINGS

FIG. 1 is a schematic view of the firmware updating system in accordance with one embodiment of the present invention;

FIG. 2 is a schematic view of the system shown in FIG. 1 during the updating process;

FIG. 3 is a flowchart of the firmware updating method in accordance with one embodiment of the present invention;

FIG. 4 is a schematic view of the system shown in FIG. 1 during the restoration process after the failure occurs; and

FIG. 5 is a flowchart of the firmware updating method during the restoration process after the failure occurs.

### DETAILED DESCRIPTION

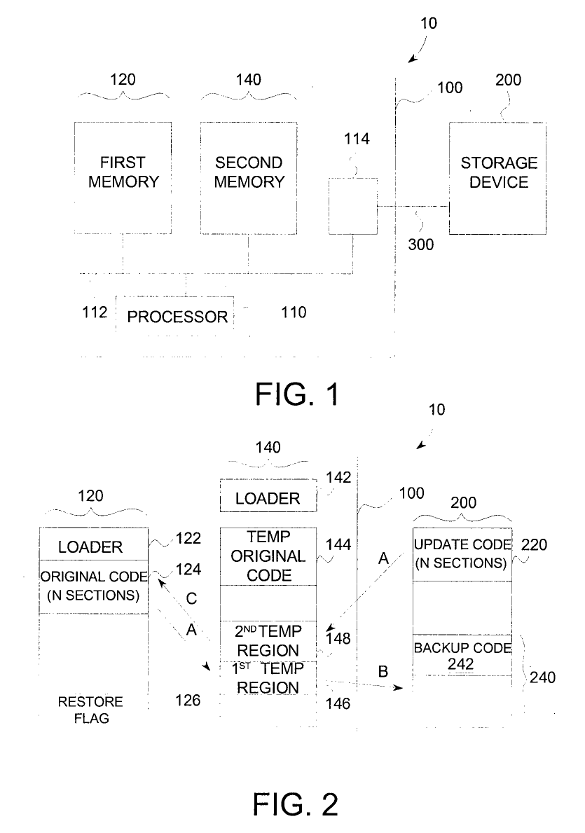

FIG. 1 is a schematic view of the firmware updating system 10 in accordance with one embodiment of the present invention. The firmware updating system 10 includes an electronic device 100 and a storage device 200. The electronic device 100 is coupled to the storage device 200 via a communication link 300. The electronic device 100 has a processor 110, a bus 112, an I/O interface 114, a first memory 120 and a second memory 140. The processor 110 accesses the I/O interface 114, the first memory 120 and the second memory 140 via the bus 112. Any conventional central processing unit may be implemented as the processor 110, including a CISC processor, a RISC processor, an embedded processor, a single chip, and the like. The first memory 120 is a non-volatile memory, such as a flash memory, EPROM, EEPROM, magnetic non-volatile memory, or the like. The second memory 140 may be a high speed memory, such as SDRAM, SRAM, cache memory, or the like. The second memory 140 is configured to temporarily store an program code for execution by the processor 110. The I/O interface 114 and the communication link 300 are varied according to the implementation of the storage device 200. In this embodiment, for example, the storage device 200 is a memory card, such as SD card, CF card, MS card or the like, and the I/O interface 114 is a card reader providing a slot to receive and access the memory card. In another embodiment, the storage device 200 is a storage server located at a remote site, hence the I/O interface 114 is a communication adaptor for communicating with the server via the communication link 300, including wired links, such as cable, optical fiber, telephone wire, Ethernet cable, etc., and wireless links, such as IEEE 802.11 series, WiFi, Bluetooth, GPRS, 3G, etc. Further, in another embodiment, the storage device 200 is an external storage apparatus, such as a portable flash memory, portable hard drive, etc, and the I/O interface 114 is a Universal Serial Bus (USB) interface, and the communication link 300 is a USB cable.

It should be noted that the firmware updating system 10 shown in FIG. 1 is an exemplary structure and that the invention is not limited to the illustrated structure. Some other components are omitted for conciseness. For example, the electronic device 100 may further include other prior art components, such as a display device, audio device, input device, power supply, and any other components or devices for specific applications. Although the storage device 200 is described as an external device in FIG. 1, those who skilled in the art may understand that the storage device 200 may be implemented as an internal device, such as a CD-ROM, a floppy disc, or the like, embedded in the electronic device 100.

FIG. 2 is a schematic view of the system 10 shown in FIG. 1 during the updating process. It should be noted that some prior art components are omitted in FIG. 2 for conciseness and the implementation should not be regarded as limitations to the present invention. The storage device 200 has an update code 220 and a backup region 240 for storing a backup code 242. The first memory 120 stores a loader program 122, an original code 124 and a restore flag 126. The conventional loading process while booting the electronic device 100 is described first in order to have a better understanding of the present invention. When the electronic device 100 is powered on, the processor 110 loads the loader program 122 to the second memory 140, shown as a temporary loader program 142 in FIG. 2, for performing basic hardware operations and initializations. The processor 110 then uses the loader program 142 to load the original code 124 into the second memory 140, shown as a temporary original code 144, for performing booting procedures. It should be noted that the temporary loader program 142 stored in a separated region in the second memory 140 as shown in FIG. 2 is merely a logical view for addressing two stages during the booting procedures. The temporary loader program 142 and the temporary original code 144 may be repeatively stored within in the same physical memory 140, or alternatively in different physical memories included in an identical logical memory.

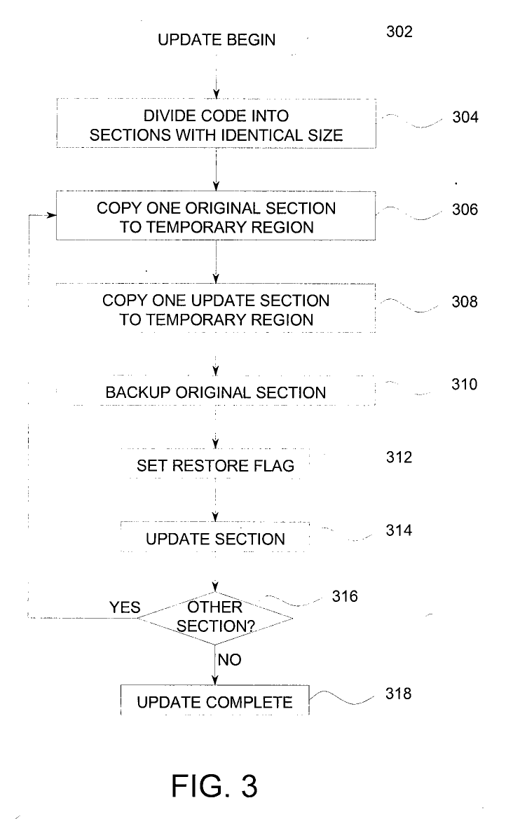

Referring to FIG. 2, when the updating process is performed to the original code 124, the processor 110 copies the original code 124 through the second memory 140 to the backup region 240 as indicated by the backup code 242. Also, the restore flag 126 is enabled. Thereafter, the original code 124 in the first memory 120 is replaced with the update code 220. Referring to FIG. 3 together with FIG. 2, the original code 124 is divided into a plurality of original sections of identical size, such as N sections shown in FIG. 2. Meanwhile, the update code 220 is correspondingly divided into a plurality of update sections of the identical size, such as N update sections shown in FIG. 2. The original sections and update sections are copied to the second memory 140, indicated as Arrow A in FIG. 2. First, one of the plurality of original sections is copied to a first temporary region 146 of the second memory 140. The corresponding one of the plurality of update sections is copied to a second temporary region 148 of the second memory 140. Thereafter, the original section in the first temporary 146 is copied to the backup region 240 of the storage device 200, as indicated as Arrow B in FIG. 2. After the original section is backed up, the update section in the second temporary region 148 is copied to the first memory 120 to replace the corresponding original section, as indicated as Arrow C in FIG. 2. The amount of original sections for storing the original code 124 is arbitrarily decided according to different embodiments or situations. The first temporary region 146 and second temporary region 148 are reserved in the second memory 140 according to the size of each original section. It should be noted that the original code in divided into sections for efficiency consideration, such as reduction of the space requirement of the second memory 140. However, even copying the original code as a whole is acceptable. Further, the first temporary region 146 and the second temporary region 148 may be sequentially separately arranged in the same physical memory, or even arranged in different physical memory within one logical memory structure. The original code is updated section by section until all of the sections are updated.

FIG. 3 is a flowchart of the firmware updating method in accordance with one embodiment of the present invention. The method begins in step 302 to check the size of the original code 124, the available space of the backup region 240 in storage device 200. If the size of the original code 124 is larger than the available space of the backup region 240, the update process is aborted, or prompts the user to decide whether to continue the process. It should be noted that the step for checking the available space of backup region 240 is optional. The present invention may provide limited restore capability for the original code even when the available space is insufficient and the updating process may still be performed.

After the checking step, the original code 124 and the updated code 220 are respectively divided into sections of identical size. The “divide” mentioned here is not limited to physical separation; a logical separation is also acceptable. In step 306, one of the plurality of original sections is copied to a first temporary region 146 of the second memory 140. In step 308, the corresponding one of the plurality of update sections is copied to a second temporary region 148 of the second memory 140. In step 310, the original section in the first temporary 146 is copied to the backup region 240 of the storage device 200. In step 312, the restore flag 126 is enabled. In step 314, the update section in the second temporary region 148 is copied to the first memory 120 to replace the corresponding original section. In step 316, it is determined if still remaining section 126 needs to be updated. If yes, the process returns to the step 306. If not, the restore flag is disabled and the process ends in step 318.

It should be noted that the present invention is not limited to the specific processing sequence as set forth in the above description and as shown in FIG. 3. For example, the update section may be copied to temporary region before the original section. Alternatively, the restore flag may be enabled at the beginning of the process, or at any other stages according to the design purpose. In this embodiment, a single restore flag 126 is used to indicate the update status of the original code 124. However, multiple flags may be respectively assigned to each section of the original code 124. Furthermore, other additional information of the updating process may be stored in the backup region 240, as described hereinafter.

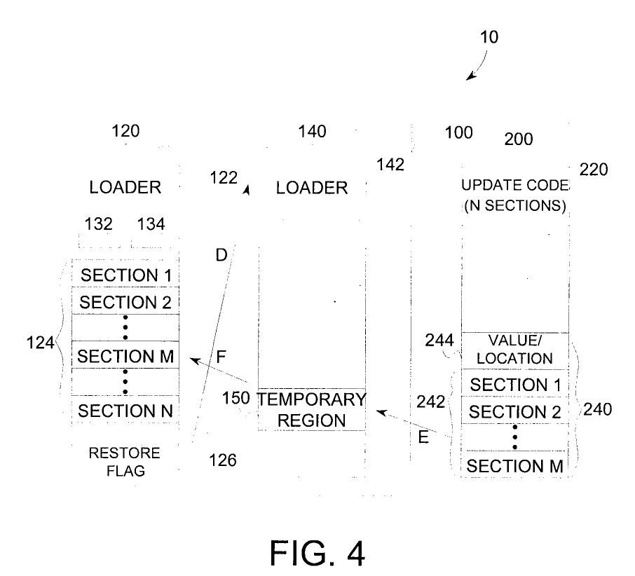

FIG. 4 is a schematic view of the system 10 shown in FIG. 1 during the restoration process after the failure of updating process occurs. In this embodiment, the original code 124 and update code 220 are respectively divided into N sections, and the system 10 replaces the original code 124 with the update code 220 section by section. The amount of updated original sections as well as the location of the backup code will be recorded as the additional information 244 in the backup region 240. Assuming a failure, such as an unexpected shutdown, has occurred at the update process proceeding to the M^{th} section of the original code, as shown in FIG. 4, the recorded value in the additional information 244 is M.

When the system 10 reboots from a system failure, the loader program 122 is re-loaded to the second memory 140. In this embodiment, the loader program 122 includes a load module 132 and a restore module 134. The processor 110 executes the load module 132 to detect status of the restore flag 126, indicated as Arrow D in FIG. 4. If a previous updating process is successful, i.e. in a normal booting process, the restore flag 126 is disabled indicating the original code 124 is ready for work. Thus, the processor 110 executes the load module 132 to load the original code 124 to the second memory 140 in a normal procedure. In the example shown in FIG. 4, an unexpected failure has occurred previously during an updating process resulting in the enabled restore flag enabled. When the processor 110 executes the load module 132 and detects the restore flag 126 as being enabled, the processor 110 further executes the restore module 134 to build up a connection between the electronic device 100 and the storage device 200 via the communication link 300. The processor 244 further accesses the additional information 244 in the storage device 200, i.e., the updated section number (M in this example) and address location of the backup code 242. Based on the additional information, the processor 110 copies the first section of the backup code 242 to the temporary region 150 in the second memory 140, indicated as Arrow E. The backup section in the temporary region 150 is then copied to the first memory 120 to replace the corresponding section of corrupted original code 124, indicated as Arrow F. The processor 110 continues the restoration section by section until the M^{th} section of backup code 242 is successfully restored to the first memory 120. The processor 110 then disables the restore flag 126 and deletes the data stored in the backup region 240. The restoration process is successful and the system 10 is able to perform normal operations, i.e., loading the restored original code 124 to the second memory 140 for further execution.

The firmware updating system 10 is one exemplary embodiment in accordance with the present invention. However, various changes may be made without departing from the spirit and scope of the invention. For example, the original code 124 may be completely copied to the backup region 240 at the beginning of the updating process without recording the additional information. When an unexpected failure has occurred, the system 10 restores the entire backup code 242 in the backup region 240 to the first memory 120 to replace the entire corrupted original code 124. Alternatively, the original code 124 may be divided into sections of varied sizes depending on the characteristic of the original code 124, and the updating code 220 is respectively divided. The additional information 242 may further include size and location of each section. Therefore, the storage device 200 is not required to preserve a fixed and continuous available space for the backup region 240; thus the storage space utilization of the storage device 200 becomes more flexible. In yet another embodiment, the restore flag 126 and the additional information 244 may be stored in different places according to design purpose. For example, the restore flag 126 may be embedded as a part of the loader program 122, or alternatively as part of the original code 124. The additional information 244 may be stored in the first memory 120 entirely, or partially in the first memory 120 and partially in the storage device 200. In accordance with another embodiment, the backup code 242 may be copied to the first memory 120 directly to replace the corrupted original code 12, thus without being temporarily stored in the temporary region of the second memory 140. In other words, the present invention is not limited to the embodiment described above and various modification can be made depending on different hardware structure or specific application.

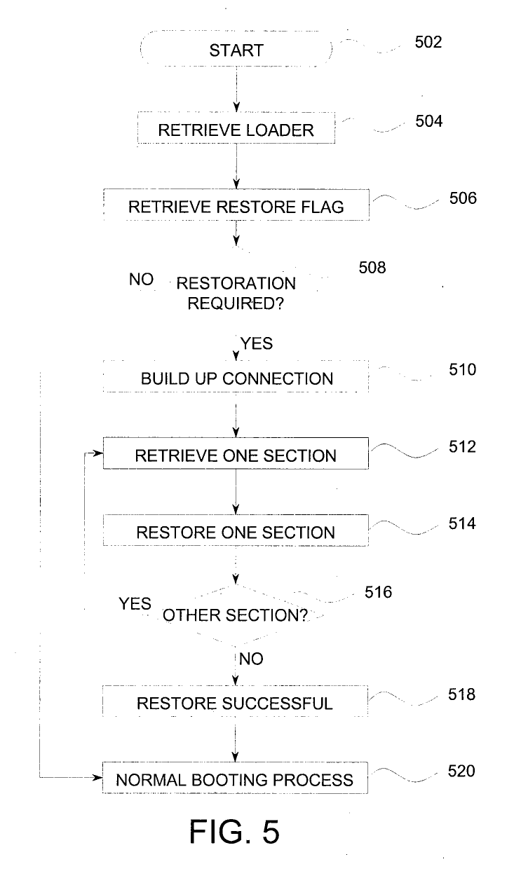

FIG. 5 is a flowchart of the firmware updating method during the restoration process after the failure occurred. Referring to FIG. 5 together with FIG. 4, the method begins in step 502. In step 504, the processor 110 loads the loader program 122 to the second memory 140. In step 506, the processor 110 executes the load module 132 to access the restore flag 126. In step 508, the processor 110 checks the status of the restore flag 126 to determine whether a restoration of the original code 124 is needed. If the restore flag 126 is disabled, the process proceeds to step 520. The processor 110 executes the load module 132 of the loader program 122 to perform a normal booting process. If the restore flag 126 is enabled, the processor 110 further executes the restore module 134 to build up a connection between the electronic device 100 and the storage device 200 via step 510. In step 512, the processor 110 copies the backup section from the backup region 240 to the first memory 120 to replace the corresponding section of corrupted original code 124. In step 516, the processor 110 determines if a still remaining section needs to be restored based on the additional information 244. If yes, the process returns to the step 512. If not, the restore flag is disabled and the data in the backup region 240 may be optionally deleted. At last, the process proceeds to step 520 to perform a normal booting process.

The above description only sets forth preferred embodiments of the invention, and is not intended to limit the scope, applicability, or configuration of the invention in any way. Rather, various changes may be made in the function and arrangement of the elements described in the embodiments without departing from the spirit and scope of the invention. Thus, the protected scope of the present invention is as set forth in the appended claims.

What is claim is:

1. A system for updating a program, the system comprising:
a storage device storing an update code related to the program and having a backup region for storing a backup code; and
an electronic device coupled to the storage device, the electronic device including:
a processor;
a first memory storing an original code and a restore flag; and
a second memory configured to temporarily store the original code for execution by the processor;
wherein the original code is backed up, through the second memory, to the backup region as the backup code, the restore flag is enabled, and the original code in the first memory is replaced by the update code.

2. The system of claim 1, the second memory further comprising:
a first temporary region; and
a second temporary region;
wherein the original code is backed up to the backup region through the first temporary region and the update code replaces the original code in the first memory through the second temporary region.

3. The system of claim 2, wherein the original code comprises a plurality of original sections, and the update code correspondingly comprises a plurality of update sections, and wherein when one of the plurality of original sections is backed up to the backup region through the first temporary region, one of the plurality of update sections replaces the corresponding one of the plurality of original sections through the second temporary region.

4. The system of claim 3, wherein the storage device further comprises a backup count and an address information stored within the backup region, the backup count indicating number of sections already backed up in the backup region, and the address information indicating location of the backup code in the storage device.

5. The system of claim 3, wherein the first memory further stores an update count and an address information, the update count indicating number of sections already updated in the first memory, and the address information indicating location of the backup code in the storage device.

6. The system of claim 1, wherein the first memory further stores a loader program, the loader program comprising: a load module; and a restore module for execution by the processor; wherein when the loader program is executed by the processor and the load module detects the restore flag is enabled, the restore module accesses the storage device and restores the backup code to the first memory.

7. The system of claim 6, wherein when the backup code is restored to the first memory, the restore flag is disabled and the backup code is deleted.

8. The system of claim 1, wherein when the update code successfully replaces the original code in the first memory, the restore flag is disabled and the backup code is deleted.

9. A method for updating a program of an electronic device from a storage device, the electronic device having a first memory and a second memory, an original code related to the program being stored in the first memory and an update code being stored in the storage device, the method comprising:
(a) setting a temporary region in the second memory;
(b) setting a backup region in the storage device;
(c) setting a restore flag to be enabled in the first memory;
(d) copying the original code to the backup region as a backup code through the temporary region; and
(e) replacing the original code in the first memory with the update code through the temporary region.

10. The method of claim 9, wherein the temporary region comprises a first temporary region and a second temporary region, the method further comprising:
backing up the original code to the backup region through the first temporary region; and
replacing the original code with the update code in the first memory through the second temporary region.

11. The method of claim 9, wherein the original code comprise a plurality of original sections, and the update code correspondingly comprises a plurality of update sections, the step (d) and (e) further comprising the following steps:
(f) copying one of the plurality of original sections to the backup region through the temporary region;
(g) copying one of the plurality of update sections to replace the corresponding one of the plurality of original sections through the temporary region;
(h) setting a backup count and an update count respectively indicating number of sections already backed up in the backup region and updated in the first memory;
(i) setting an address information indicating location of the backup code in the storage device; and
(j) repeating step (f) to (i) until all of the original sections are replaced with the updated sections.

12. The method of claim 9, wherein the first memory further stores a loader program, the loader program including a load module and a restore module, the method further comprising:
(k) when the loader program is executed by a processor and the load module detects the restore flag is enabled, the restore module accessing the storage device and restoring the backup code to the first memory; and
(l) the load module loading the original code to the second memory.

13. The method of claim 12, further comprising the following steps:
(m) when the backup code is restored successfully to the first memory, disabling the restore flag and deleting the backup code.

14. The method of claim 12, further comprising the following steps:
(n) when the update code successfully replaces the original code in the first memory, disabling the restore flag and deleting the backup code.

15. The method of claim 11, wherein the backup count and the address information are stored in the storage device.

16. The method of claim 11, wherein the update count and the address information are stored in the first memory.

17. The method of claim 9, wherein when a available space of the storage device is not enough for configuring as the backup region, terminating the update process.
